(19) United States
(12) Patent Application Publication
(10) Pub. No.: US 2010/0010861 A1
(43) Pub. Date: Jan. 14, 2010

(54) METHOD AND SYSTEM FOR PROVIDING A VIRTUAL COLLECTIONS CALL CENTER SYSTEM

(75) Inventors: Ye Zhang, Wilmington, DE (US); Vytas Alfonsas Kisielius, Wilton, CT (US)

Correspondence Address: PEPPER HAMILTON LLP, ONE MELLON CENTER, 50TH FLOOR, 500 GRANT STREET, PITTSBURGH, PA, 15219, US

(73) Assignee: COLLECTIONS MARKETING CENTER, LLC, Wilmington, DE (US)

(21) Appl. No.: 12/501,622

(22) Filed: Jul. 13, 2009

Related U.S. Application Data
(60) Provisional application No. 61/079,878, filed on Jul. 11, 2008.

(51) Int. Cl. G06Q 10/00; G06Q 40/00; G06Q 50/00; H04M 3/00; H04M 1/64

(52) U.S. Cl. 705/9; 705/11; 705/7; 705/30; 379/265.09; 379/88.04; 379/88.17

(57) ABSTRACT

Methods and systems for operating a virtual collections call center system are described. A system may include a database server, a telephony server, an auto dialer system, a Web server, and call agent computer systems, each geographically separated from the database server, the telephony server, the auto dialer system, the Web server and other call agent computer systems. The database server may store debtor records, each including a debtor telephone number. The telephony server may retrieve a debtor record from the database server. The auto dialer system may initiate a communication session with a debtor based on the debtor telephone number of the retrieved debtor record, establish a connection with the call agent after the debtor has accepted the communication session, and alert the telephony server that the communication session has been established. The Web server may initiate a Web session with the call agent computer system.

### CLAIM OF PRIORITY

This application claims the benefit and priority of U.S. Provisional Patent Application No. 61/079,878 entitled “Method and System for Providing a Virtual Collections Call Center System” and filed Jul. 11, 2008, which is incorporated herein by reference in its entirety.

NOT APPLICABLE

### BACKGROUND

Debt collection balances have grown dramatically over the past decade. Consumer loan debt now exceeds 2.5 trillion dollars with over 100 billion dollars in a collection status. Moreover, the amount in collection status merely includes consumer loan collections. Additional debt collection balances arise from bill pay obligations such as from medical bills, utilities, services and the like. In addition, small business debt is growing rapidly as lenders seek new market opportunities.

When a debtor is unable to make payments on a loan, a debt issuer, such as a bank that issues credit, will typically seek to obtain payment for the outstanding balance. Some debt issuers employ an internal debt collection unit. The debt collection unit typically uses an automated or live calling program that attempts to contact the debtor via a telephone service. The debt collection unit could also seek to contact the debtor via other communication methods, primarily through direct mail and phone messages. Other debt issuers contract with a debt collection agency that performs similar operations in order to contact debtors.

Traditional collection call centers require an infrastructure containing complex hardware and software components. For example, conventional collection call centers must install and maintain a telephony system and a software collection inventory system that hosts debtor account information. Typically, the telephony system must include an auto-dialer system in order to manage caller efficiency while handling large volumes of customer calls. Many collection call centers have also implemented modern Voice Response Unit (VRU) functionality either within the auto-dialer system or as an add-on function from service providers. Interfaces must be provided for each of the above debtor contact systems. Moreover, maintenance of such systems is necessary in order to ensure that accurate information can be provided to call agents by the telephony system.

In some cases, a debt issuer or debt collection agency maintains a plurality of call centers. This may particularly be the case for large creditors or collection agencies. In such a scenario, each call center must include a separate hardware and software platform with only loose ties between call centers. For example, while each call center can typically access debtor information from or be provided with information by a central database containing debtor information for the debt issuer or debt collection agency, the call centers do not directly communicate with each other (or only do so on a limited basis). In some cases, the call centers can even use different software or hardware systems that are incompatible with the systems used by other call centers.

### SUMMARY

Before the present methods are described, it is to be understood that this invention is not limited to the particular, methodologies or protocols described, as these may vary. It is also to be understood that the terminology used herein is for the purpose of describing particular embodiments only, and is not intended to limit the scope of the present disclosure.

It must be noted that as used herein, the singular forms “a,” “an,” and “the” include plural reference unless the context clearly dictates otherwise. Thus, for example, reference to a “transaction” is a reference to one or more transactions and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of the present invention, the preferred methods, devices, and materials are now described. All publications mentioned herein are incorporated herein by reference. Nothing herein is to be construed as an admission that the invention is not entitled to antedate such disclosure by virtue of prior invention.

A completely integrated and purely web-based collection system that frees call centers from installing and maintaining collection inventory systems and advanced telephony systems is disclosed. The disclosed collection system provides coordinated control of call activities and visibility to all contact methods through a single interface to the call agents. Accordingly, call agents need not be centrally located as with typical call center systems. Rather, calling may be performed from a plurality of locations, including remote locations, based on the teachings disclosed herein.

In an embodiment, a virtual collections call center system may include a plurality of call agent computer systems, including a first call agent computer system associated with a call agent and a plurality of second call agent computer systems, a database server configured to store a plurality of debtor records, each including a debtor telephone number, a telephony server, in operable communication with the database server, configured to retrieve a debtor record from the database server, an auto dialer system, in operable communication with the telephony server, configured to initiate a communication session with a debtor based on the debtor telephone number of the retrieved debtor record, establish a connection with the call agent after the debtor has accepted the communication session, and alert the telephony server that the communication session has been established, and a Web server, in operable communication with the telephony server, configured to initiate a Web session with the first call agent computer system. The first call agent computer system is geographically separated from the database server, the telephony server, the auto dialer system, the Web server, and the plurality of second call agent computer systems.

In an embodiment, a method of operating a virtual collections call center system may include retrieving, via a telephony server, a debtor record from a database server containing a plurality of debtor records, each comprising a debtor telephone number, initiating a communication session with a debtor based on the debtor telephone number associated with the retrieved debtor record, establishing a connection with a call agent in response to the debtor associated with the retrieved debtor record accepting the communication session; and initiating, via a Web server, a Web session with a call agent computer system associated with the call agent. The call agent computer system is geographically separated from the telephony server, the database server and the Web server.

### BRIEF DESCRIPTION OF THE DRAWINGS

Aspects, features, benefits and advantages of the present invention will be apparent with regard to the following description and accompanying drawings, of which:

FIG. 1 depicts a block diagram of an exemplary integrated virtual collections call center system according to an embodiment.

FIG. 2 depicts a flow diagram of an exemplary method for operating an integrated virtual collections call center system according to an embodiment.

FIG. 3 is a block diagram of exemplary internal hardware that may be used to contain or implement program instructions according to an embodiment.

### DETAILED DESCRIPTION

A “debtor” is an individual or business entity that has incurred a debt. For example, and without limitation, a debtor may include an individual that has a credit card balance, an outstanding home loan, a car loan or the like, or a business that has obtained a loan to cover business expenses. In some cases, a debtor's debt may have entered into a collections status.

A “creditor” is a bank, company, agency and/or business entity to which a debtor is indebted. For example and without limitation, the creditor may be a bank that has loaned money to a debtor, a credit card agency for which the debtor has a delinquent balance, or the like.

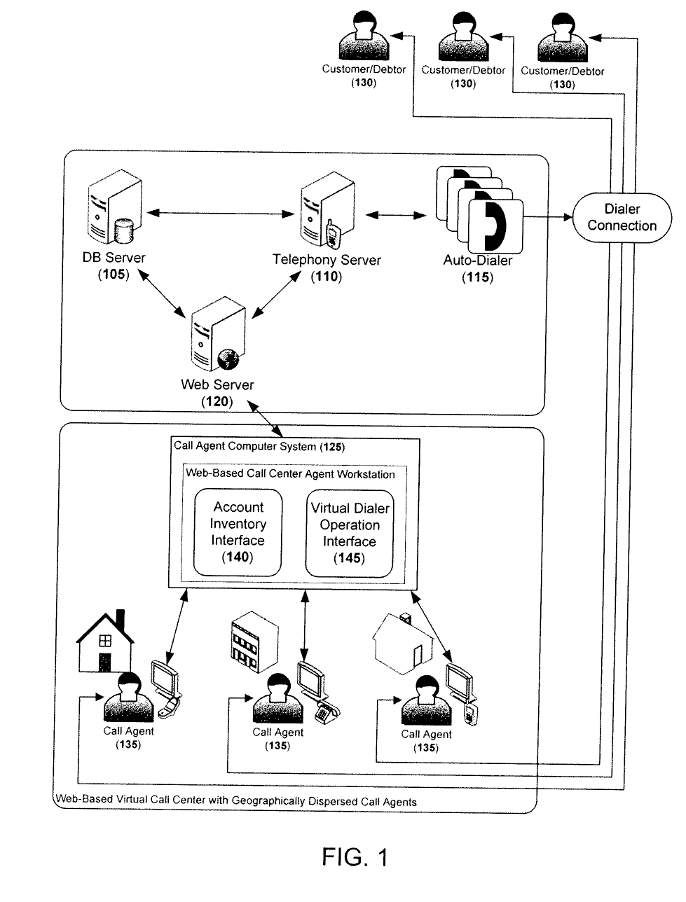

FIG. 1 depicts a diagram of an exemplary virtual collections call center system according to an embodiment. As shown in FIG. 1, the virtual call center system 100 may include a database server 105, a telephony server 110, an auto dialer system 115, a Web server 120 and a plurality of call agent computer systems 125. The virtual call center system 100 may be used, for example, to attempt to contact debtors 130 in order to obtain payment for an outstanding debt. Other uses for the virtual call center system 100 are also included within the scope of this disclosure.

The database server 105 may maintain a database containing one or more records for each debtor 130 from which collections are sought. Each database record stored in the database server 105 may include account information for a corresponding debtor 130, personal information for the debtor, and/or contact history and measures of effectiveness for previous attempts to contact the debtor, if any. Personal information for a debtor 130 may include the name, address, date of birth and/or social security number of the debtor, one or more telephone numbers at which the debtor may be reached, and/or other identifying information. Account information for a debtor 130 may include an account number, an amount owed by the debtor on the account, loan repayment terms, and the like. The contact history may include a record of one or more attempts, including successful attempts, that have been made to contact a debtor 130. For example, the contact history may include data pertaining to phone solicitations, mailings, calls received from the debtor 130 and the like that pertain to the debt associated with the record.

In an embodiment, the database server 105 may be integrated with and communicate with the telephony server 110 and the Web server 120. The database server 105 may provide information regarding a debtor 130 during an attempt to contact the debtor and/or when a debtor contacts the virtual call center system 100.

The telephony server 110 may control telecommunication operations that are performed when contacting a debtor 130 via a communication session. The telephony server 110 may retrieve account information pertaining to a debtor 130 from the database server 105 prior to initiating a communication session. For example, the telephony server 110 may retrieve a phone number that is associated with an account.

Once the telephone number has been retrieved, the telephony server 110 may interact with the auto dialer system 115 to place a call to the corresponding debtor 130. When the debtor 130 accepts the call (i.e., answers the telephone), the auto dialer system 115 may establish a connection with an available call agent 135. In addition, the auto dialer system 115 may alert the telephony server 110 that a phone connection has been established with the debtor 130. The telephony server 110 may then inform the Web server 120 that a successful contact has been initiated with a debtor 130.

The Web server 120 may initiate a corresponding Web session via a Web-Based Call Center Agent Workstation with a call agent computer system 125 associated with the call agent 135 that was telephonically connected with the debtor 130. The Web-Based Call Center Agent Workstation is a Web application that executes within the Web server 120 and may be accessed by one or more call center agents 135 that are each, for example and without limitation, geographically separated from the Web server. A call center agent 135 may access the Web-Based Call Center Agent Workstation using a Web browser on an associated call agent computer system 125. The Web-Based Call Center Agent Workstation may be used to display, for example and without limitation, an account inventory interface 140 and a virtual dialer interface 145 on the call agent computer system 125 associated with the call agent 135. The Web server 120 may retrieve information that is displayed in the account inventory interface 140 from at least the account record for the debtor 130 in the database server 105. For example, the account inventory interface 140 may display the name and outstanding debt of the debtor 130 as well as one or more specific terms or conditions that the call agent 135 may offer to the debtor with respect to collecting at least a portion of the outstanding debt.

The virtual dialer interface 145 may be used to launch and/or monitor one or more tools used by the call agent 135. For example, the virtual dialer interface 145 may enable the call agent 135 to launch and/or monitor a software tool that tracks the progress of an interactive voice recognition (IVR) campaign. Similarly, preview dialing, predictive dialing and/or unattended dialing campaigns may be launched or monitored using the virtual dialer interface 145. Other operations may also be performed within the scope of this disclosure.

In an embodiment, the phone and the call agent computer system 125 used by a call agent 135 are not located within a conventional call center system. Rather, the call agent 135 may initiate a connection to the virtual call center system 100 from a call agent computer system 125 that is geographically separated from the database server 105, the telephony server 110, the auto dialer system 115, and the Web server 120. In addition, the call agent computer system 125 may be geographically separated from other call agent computer systems 125 that access the virtual call center system 100.

In an embodiment, the connection between a call agent computer system 125 and the virtual call center system 100 may be secured by using, for example, the HyperText Transfer Protocol over Secure Socket Layer (HTTPS) transmission protocol. Alternately, data transferred between the call agent computer system 125 and the virtual call center system 100 may be encrypted using any known encryption/decryption protocol, including without limitation, public key encryption and/or private key encryption protocols.

During an initialization phase or when the call agent 135 is signing on, the call agent may provide information to the virtual call center system 100 regarding the telephone number to be used during one or more communication sessions. For example, the call agent 135 may provide one or more telephone numbers at which the call agent can be reached as part of a configuration process. The call agent 135 may further select a phone number to be utilized for a particular communication session. Alternately, the call agent 135 may provide a telephone number at the beginning of a communication session. In an embodiment, the telephone belonging to the call agent 135 may be pre-configured to be operated with the virtual call center system 100 by enabling specific call features.

In an embodiment, performance monitoring may be performed during a communication session. For example, activities performed by the call agent 135 via the call agent computer system 125 may be monitored and stored in a memory. In an embodiment, the memory may be located within the call agent computer system 125 and/or within one or more of the database server 105, the telephony server 110, and the Web server 120. Similarly, a voice recording of the conversation between a debtor 130 and a call agent 135 may be recorded and stored. Such performance monitoring may be used for quality assurance purposes as well as to determine the time period during which a call agent 135 responds to calls. Such monitoring may be particularly beneficial if, for example, the call agent 135 is not physically present at a location where a manager can directly monitor the call agent's performance.

In an alternate embodiment, performance monitoring may be performed with respect to characteristics of the communication session. For example, performance monitoring may be performed to identify a time period for the communication session, data input by the debtor and/or the call agent during the communication session and/or the like. Other performance characteristics may additionally or alternately be monitored within the scope of the present disclosure.

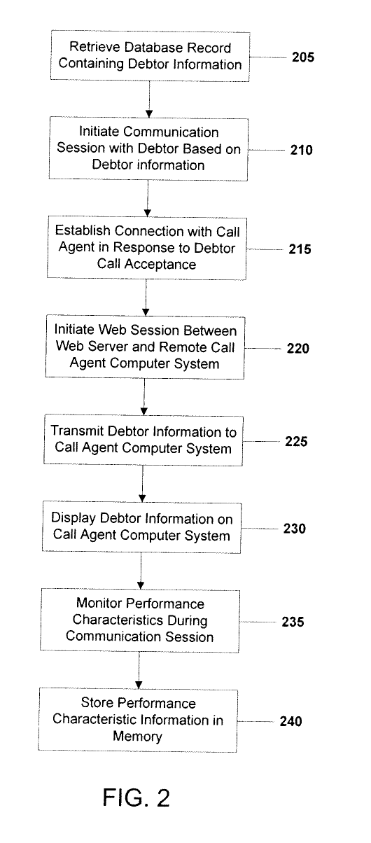

FIG. 2 depicts a flow diagram of an exemplary method of operating a virtual collections call center system according to an embodiment. As shown in FIG. 2, a telephony server may retrieve 205 a debtor record from a database server. The database server may contain a plurality of debtor records. Each debtor record may include a telephone number associated with a debtor. In an embodiment, each debtor record may further include financial account information for the debtor, personal information for the debtor, contact history information for the debtor including information pertaining to one or more previous contacts with the debtor, and an effectiveness measure for each previous contact with the debtor. Other information may also be stored in a debtor record within the scope of this disclosure.

A communication session may be initiated 210 with the debtor based on the debtor telephone number associated with the retrieved debtor record. For example, the communication session may be initiated 210 by placing a call to the debtor telephone number. In an embodiment, the communication session may be initiated 210 using an auto dialer system. Other methods of communicating with the debtor may additionally or alternately be used within the scope of this disclosure.

A connection may also be established 215 with a call agent as part of the communication session. For example, a connection may be established 215 with a call agent in response to the debtor accepting the communication session. In an embodiment, the auto dialer system may establish 215 the connection with the call agent after the debtor has picked up the phone. In an embodiment, the call agent may be selected from a pool of available call agents. The pool of available call agents may be determined by identifying one or more call agents that are not currently engaged in a communication session and that have identified themselves as being available to engage in communications sessions with debtors. A call agent may identify his or her availability by logging on to or being logged on to the virtual call center system, selecting an “Active” status option, and/or the like.

A Web session may be initiated 220 between a call agent computer system associated with the selected call agent and a Web server. In an embodiment, the call agent computer system is geographically separated from the telephony server, the database server, the auto dialer system, and the Web server. In an embodiment, the call agent computer system may further be geographically separated from call agent computer systems associated with other call agents.

The Web server may transmit 225 information to the call agent computer system associated with the call agent. In an embodiment, information such as personal information pertaining to the debtor, information from the debtor record, the outstanding debt for the debtor or the like may be transmitted 225 and displayed 230 in an account inventory interface on the call agent computer system. Additionally or alternately, the debtor's name and/or one or more terms or conditions for the outstanding debt may also be displayed in the account inventory interface as part of the Web session.

In an embodiment, information may be displayed 230 in a virtual dialer interface on the call agent computer system associated with the call agent. The virtual dialer interface may enable the call agent to launch and/or monitor a software tool that tracks the progress of an interactive voice recognition (IVR) campaign. Similarly, tools enabling preview dialing, predictive dialing and/or unattended dialing campaigns may be launched and/or monitored using the virtual dialer interface.

In an embodiment, the performance of the call agent may be monitored 235 during a communication session. In such an embodiment, activities that are performed by the call agent via the call agent computer system and/or the communication session may be monitored 235 and stored 240 in a memory. For example, a voice recording of a conversation between the debtor and the call agent may be recorded and stored 240. Such performance monitoring 235 may be used for quality assurance purposes as well as to determine the time period during which the call agent engaged in communication sessions for, for example, billing purposes. Performance monitoring 235 may be particularly beneficial if the call agent is not physically present at a location where a manager can directly monitor the call agent's performance.

In an embodiment, performance characteristics of the call agent computer system may be monitored 235 in addition to or instead of performance characteristics of the communication session. For example, performance monitoring 235 may be performed to identify data input by the call agent into the call agent computer system during the communication session and/or the like. Such information may be stored 240 in a memory. Other performance characteristics may additionally or alternately be monitored 235 and stored 240 within the scope of the present disclosure.

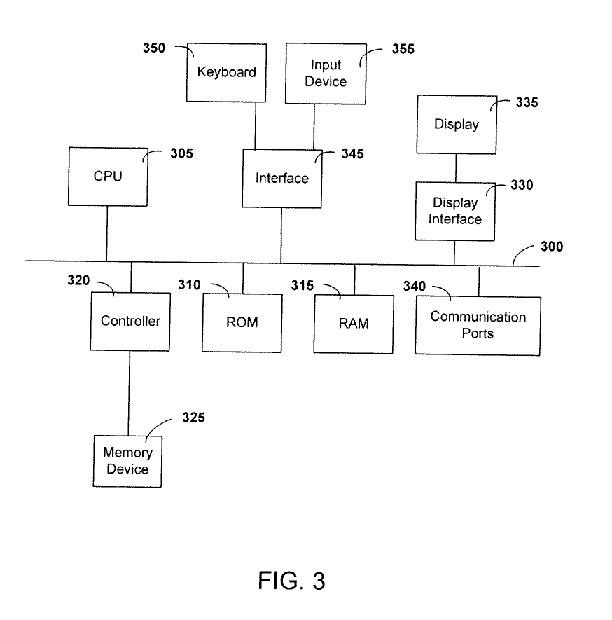

FIG. 3 depicts a block diagram of exemplary internal hardware that may be used to contain or implement program instructions according to an embodiment. A bus 300 serves as the main information highway interconnecting the other illustrated components of the hardware. CPU 305 is the central processing unit of the system (i.e., the processor), performing calculations and logic operations required to execute a program. Read only memory (ROM) 310 and random access memory (RAM) 315 constitute exemplary memory devices.

A controller 320 interfaces with one or more optional memory devices 325 to the system bus 300. These memory devices 325 may include, for example, an external or internal DVD drive, a CD ROM drive, a hard drive, flash memory, a USB drive or the like. As indicated previously, these various drives and controllers are optional devices.

Program instructions may be stored in the ROM 310 and/or the RAM 315. Optionally, program instructions may be stored on a tangible computer readable medium such as a compact disk, a digital disk, flash memory, a memory card, a USB drive, an optical disc storage medium, such as Blu-ray™ disc, and/or other recording medium.

An optional display interface 330 may permit information from the bus 300 to be displayed on the display 335 in audio, visual, graphic or alphanumeric format. Communication with external devices may occur using various communication ports 340. An exemplary communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

An embedded system may optionally be used to perform one, some or all of the operations described herein. Likewise, a multiprocessor system may optionally be used to perform one, some or all of the operations described herein.

It will be appreciated that several of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A virtual collections call center system, comprising:
a plurality of call agent computer systems, comprising a first call agent computer system associated with a call agent and a plurality of second call agent computer systems;
a database server configured to store a plurality of debtor records, wherein each debtor record comprises a debtor telephone number;
a telephony server, in operable communication with the database server, configured to retrieve a debtor record from the database server;
an auto dialer system, in operable communication with the telephony server, configured to initiate a communication session with a debtor based on the debtor telephone number of the retrieved debtor record, establish a connection with the call agent after the debtor has accepted the communication session, and alert the telephony server that the communication session has been established; and
a Web server, in operable communication with the telephony server, configured to initiate a Web session with the first call agent computer system,
wherein the first call agent computer system is geographically separated from the database server, the telephony server, the auto dialer system, the Web server, and the plurality of second call agent computer systems.

2. The system of claim 1 wherein each debtor record further comprises financial account information for an associated debtor, personal information for the associated debtor, contact history information pertaining to one or more previous contacts with the associated debtor, and an effectiveness measure for each previous contact with the associated debtor.

3. The system of claim 1 wherein the Web server is configured to cause the first call agent computer system to display an account inventory interface via the Web session, wherein the account inventory interface is configured to display information from the retrieved debtor record.

4. The system of claim 3 wherein the account inventory interface is configured to display a name and an outstanding debt for the debtor associated with the retrieved debtor record.

5. The system of claim 3 wherein the account inventory interface is configured to display one or more terms or conditions to be offered to the debtor associated with the retrieved debtor record in order to collect the outstanding debt for the debtor associated with the retrieved debtor record.

6. The system of claim 1 wherein the Web server is configured to cause the first call agent computer system to display a virtual dialer interface via the Web session, wherein the virtual dialer interface is configured to display information pertaining to an interactive voice recognition campaign.

7. The system of claim 1 wherein the Web server is configured to cause the first call agent computer system to display a virtual dialer interface via the Web session, wherein the virtual dialer interface is configured to display information pertaining to a preview dialing operation.

8. The system of claim 1 wherein the Web server is configured to cause the first call agent computer system to display a virtual dialer interface via the Web session, wherein the virtual dialer interface is configured to display information pertaining to a predictive dialing operation.

9. The system of claim 1 wherein the Web server is configured to cause the first call agent computer system to display a virtual dialer interface via the Web session, wherein the virtual dialer interface is configured to display information pertaining to an unattended dialing operation.

10. The system of claim 1, further comprising:
a memory configured to store information pertaining to one or more activities from the communication session.

11. The system of claim 10 wherein the memory is configured to store a voice recording from the communication session.

12. The system of claim 10 wherein the memory is configured to store performance data pertaining to one or more of the communication session, the call agent and the first call agent computer system.

13. A method of operating a virtual collections call center system, the method comprising:
retrieving, via a telephony server, a debtor record from a database server containing a plurality of debtor records, wherein each debtor record comprises a debtor telephone number;
initiating a communication session with a debtor based on the debtor telephone number associated with the retrieved debtor record;
in response to the debtor associated with the retrieved debtor record accepting the communication session, establishing a connection with a call agent; and
initiating, via a Web server, a Web session with a call agent computer system associated with the call agent,
wherein the call agent computer system is geographically separated from the telephony server, the database server and the Web server.

14. The method of claim 13 wherein the retrieved debtor record further comprises financial account information for a debtor, personal information for the debtor, contact history information for the debtor including information pertaining to one or more previous contacts with the debtor, and an effectiveness measure for each previous contact with the debtor.

15. The method of claim 13, further comprising:
displaying information from the retrieved debtor record on the call agent computer system via the Web session.

16. The method of claim 15 wherein displaying information from the retrieved debtor record comprises displaying a name and an outstanding debt for the debtor associated with the retrieved debtor record.

17. The method of claim 15 displaying information from the retrieved debtor record comprises displaying one or more terms or conditions to be offered to the debtor associated with the retrieved debtor record.

18. The method of claim 13, further comprising:
displaying, via the Web session, information pertaining to an interactive voice recognition campaign on the call agent computer system.

19. The method of claim 13, further comprising:
displaying, via the Web session, information pertaining to one or more of a preview dialing operation, a predictive dialing operation, and an unattended dialing operation on the call agent computer system.

20. The method of claim 13, further comprising:
storing information pertaining to one or more activities from the communication session in a memory.

21. The method of claim 20 wherein storing information pertaining to one or more activities comprises storing a voice recording from the communication session.

22. The method of claim 20 wherein storing information pertaining to one or more activities comprises storing performance data pertaining to one or more of the communication session, the call agent, and the call agent computer system.
